(19) United States
(12) Patent Application Publication
(10) Pub. No.: US 2007/0102640 A1
(43) Pub. Date: May 10, 2007

(54) APPARATUS AND METHOD FOR DETECTION OF FISSIONABLE MATERIALS

(76) Inventors: Harry Ing, Deep River (CA); Hugh Robert Andrews, Pembroke (CA)

Correspondence Address: IAN FINCHAM, SUITE 606, 225 METCALFE STREET, OTTAWA, ON, K2P 1P9, CA

(21) Appl. No.: 11/308,994

(22) Filed: Jun. 5, 2006

Related U.S. Application Data
(60) Provisional application No. 60/595,091, filed on Jun. 6, 2005.

(51) Int. Cl. G01N 23/22

(52) U.S. Cl. 250/358.1; 250/390.04; 250/390.01

(57) ABSTRACT

An apparatus and method for the detection of fissionable materials (e.g. uranium and plutonium) in cargo, vehicles, soil, waste, etc. utilizing a penetrating photon beam causing emission of neutrons from such materials. The neutrons are detected by selected detectors able to function throughout an appropriate test and emission period. Suitable detectors are of the super-heated droplet type. The photon energy, beam intensity and direction, number of beams, emission period and detector arrangement are chosen to give the desired sensitivity for the fissionable elements of concern.

### FIELD OF THE INVENTION

The detection of fissionable materials (e.g. U, Pu, Th) within cargo, subsurface soil, waste and the like is achieved by probing with a photon beam able to cause emission of some fission-derived neutrons and providing selected means to detect such neutron emissions.

### BACKGROUND AND PRIOR ART

Detection of illicit fissionable materials remains one of the greatest technical challenges in the field of nuclear counter-terrorism. These materials can be the main ingredients of a dirty bomb or, even worse, an atomic bomb or improvised nuclear device. Although plutonium (Pu) is a very worrisome material, it emits neutrons from spontaneous fission in its natural state and the neutrons (despite their low abundance) along with some gamma rays (from alpha decay) can be utilized for determining its presence. Other fissionable materials are much more difficult to detect.

Enriched uranium is very difficult to detect with current technology because it emits practically no radiation in its natural state due to its long half-life. The very few gamma rays that it does emit are low in energy and can be easily shielded by a small thickness of lead. Thus, the detection of enriched uranium (mainly ²³⁵U) is not practical using passive radiation detectors, such as those deployed for other potential dirty bomb materials such as ¹³⁷Cs and ⁶⁰Co, which are strong gamma-ray emitters.

The detection of fissionable materials, such as ²³⁹Pu and ²³⁵U, by “active interrogation” techniques has been done for many years. These techniques have been applied, for instance, in the detection and quantification of fissionable materials in laboratory waste in connection with nuclear fuel processing. The most common active interrogation methodology is to use neutrons as the “probe” and to detect all of the radiations (neutrons and gamma rays) from induced fission. The main challenge to this approach is distinguishing the neutrons used as the probe from the radiation created by the ensuing fission process. Techniques that have been deployed include: using a pulsed neutron source and detecting the resulting radiation in-between the pulsed sources of neutrons; using thermal neutrons as the probe and detecting only fast neutrons from the induced fission; and using several radiation detectors in time-coincidence, taking advantage of the fact that only fission produces a multiplicity of simultaneous emissions. All of these techniques require sophisticated and complicated timing electronics for proper operation. Generally these techniques detect only the less abundant delayed neutrons and not the abundant prompt neutrons.

Another technological approach for “active interrogation” involves using high-energy photons as the probe and detecting the resulting radiation from fission using conventional radiation detectors such as gas counters or scintillators. This technique has not been used commonly because of the inability to suppress the influence of the probing photons on the conventional radiation detectors. The intensity of the probing photons is generally so high that it saturates the detectors and prevents them from detecting the desired resulting radiation from fission.

The following references are typical of such prior techniques.

U.S. Pat. No. 5,495,106, Feb. 27, 1996, G. F. Mastny.

Nuclear Science and Engineering, Vol. 73, p. 153-163 (1980), J. T. Caldwell et al.

Physical Review C., Vol. 21., No. 4. p. 1215-1231 (1980), J. T. Caldwell et al.

There is presently a need for an apparatus and method in which continuous inspection of targets is possible for detection of fissionable materials. Further, there is a need for an apparatus and method which allows for immediate detection of fission induced by the photon beam.

### SUMMARY OF THE INVENTION

The invention includes an apparatus for detection of fissionable material in cargo, waste, subsurface soil and like targets comprising: a photon source selected to provide a photon beam able to penetrate the target, and able to cause emission of neutrons substantially only from fissionable material to be detected; detection means including at least one neutron detector selected and positioned to be substantially unaffected by the photon beam and able to detect, throughout said emission period, fission-derived neutrons; and, means to read each detector thereby to determine the presence of fissionable material.

The invention further includes a method of detecting fissionable material in various targets, comprising: penetrating the target with a photon beam selected to cause emission of neutrons from fissionable material to be detected over an appropriate period; detecting the resulting fission-derived neutrons throughout said emission period with selected detector means; and, reading the detector means thereby to determine the presence of fissionable material.

The photon beam energy and intensity and number of beams is selected to provide desired sensitivity for detection of the fissionable material. The detection system is selected to function while the photon beam is “ON” and throughout an appropriate neutron emission period.

### DETAILED DESCRIPTION

The present invention involves an alternative technique that is very suitable for the detection of illicit fissionable materials such as ²³⁹Pu and ²³⁵U. This technique is a special application of the conventional “photon in, neutron out”, i.e. (y, n), approach. This specialized approach invokes conditions and selections relating to both the photon probe and the detector technology.

The Detector Technology

The interrogating photon beam would normally create havoc with conventional neutron (or gamma) detectors that are needed to detect the neutrons from the fission event. The intensity of the beam would normally render these detectors inoperative due to electronic saturation. However, there exists a relatively new class of radiation detectors that are now referred to as superheated droplet-type detectors and superheated droplet (emulsion) detectors and superheated droplet (gel) detectors being two embodiments of this class of detectors. The latter are often referred to as “bubble detectors”. For example, see Bubble Detector Patents: U.S. Pat. No. 4,613,758 and No. 5,105,088, by H. Ing et al. Superheated Droplet Detector Patents: U.S. Pat. No. 4,143,274 and No. 4,350,607 by Robert E. Apfel.

In these detectors, droplets are dispersed in suitable suspending media which are unaffected by the superheat temperature. Where the suspending media are liquid (e.g. emulsion) the resulting bubbles are free to move and coalesce (and sensitivity is reduced). Where the media are solidified (e.g. gel) the resulting bubbles are constrained and can be detected individually (i.e. improved sensitivity). When used herein “superheated droplet-type detector” is meant to include both emulsion and gel types.

The unique feature of such detectors and particularly bubble-type detectors is their high sensitivity to neutrons and lack of sensitivity to gamma radiation. This property is one of the main reasons why bubble detectors are deployed in medical facilities for measuring unwanted neutrons from radiation therapy treatments using Bremsstrahlung beams. It is this same property that makes the bubble detector highly suitable for detecting the neutrons produced by an interrogating photon beam.

A superheated droplet technology, for example, can be used to detect the neutrons from fission induced by a selected photon beam. By its intrinsic insensitivity to gamma radiation, the performance of the superheated droplet-type detector will not be adversely affected by the interrogating beam that would normally create havoc in other types of detectors. This means that the detector can be left “on”, even when the photon beam is interrogating the target, thereby eliminating the need for sophisticated timing electronics. Furthermore, since the majority of fission-related neutrons are produced essentially instantaneously when the fissionable material is interrogated by the photon beam, the fact that the detector can be “on” while the interrogation occurs drastically increases both the duty cycle and the sensitivity of this detection method as compared to other active interrogation techniques. Additionally, in order to optimize the response of the detector to neutrons from fission, the energy threshold of the detector can be adjusted by controlling the temperature, pressure, or chemical formulation of the superheated droplet detector liquid. The superheated droplet detector makes for a sensitive, simple and inexpensive neutron detector perfectly suited for this application. Detectors in a wide range of sizes and configurations can be made so that even tiny amounts of fissionable material can be detected rapidly. When neutrons are produced by the interrogating beam on a sample under examination, bubbles suddenly form in the gel medium of the bubble detector. The formation of these bubbles can be detected by a wide range of techniques, including but not limited to: optical techniques, acoustic techniques, light-scattering techniques with optical reading, imaging, electrical conductivity techniques, sound propagation, etc. Recompression of the bubbles into superheated liquid droplets (so that the detector can be re-used) can be achieved through a variety of techniques, including but not limited to: mechanical recompression, hydraulic recompression, gas-driven recompression, etc. The detector's response to neutrons as a function of temperature can be controlled through appropriate environmental enclosures or through temperature compensation techniques, including but not limited to, controlling the pressure of the detector medium to ensure a consistent degree of superheat in the detector liquid. Am array of detectors is used for the purpose of inspecting objects such as, for example, cargo containers, rail cars or the like. The detectors can be assembled in a “portal monitor” fashion (i.e. detectors on either side of a road or track, with several detectors arranged side by side, with perhaps additional rows of detectors stacked above). The accelerator can also be positioned in several locations depending on the environment and specific application. One such application can involve positioning the accelerator in the road pointing skyward. Alternatively, the accelerator can be located just prior to the detectors and oriented with the beam approximately parallel with the ground or tilted upward (so that the container is interrogated from the side). It is less desirable for the interrogating beam to be pointed towards the ground as this may create significant backscattering. Further, it is undesirable to have the interrogating beam pointing directly at the detectors, since this creates an unnecessarily harsh operating environment for the detector electronics.

Photon Probe Condition

Essentially all materials that are not fissionable have (y, n) thresholds higher than 6 MeV, with the exception of D, Be, ¹³C, ¹⁷O, ¹⁴⁹Sm and ¹⁵¹Sm. Of these, D and Be are controlled substances and their presence is also of interest in counter-terrorism applications. The isotopes of ¹³C and ¹⁷O occur in low abundance in nature and do not pose a serious problem in terms of the proposed approach. Sm is a rare element and not commonly found in normal everyday materials. The fissionable elements ²³⁹Pu and ²³⁵U have (y, n) thresholds of 5.65 MeV and 5.30 MeV respectively (other fissionable isotopes have thresholds of comparable energies). By keeping the energy of the interrogating photons below about 6 MeV (or slightly above depending on the optimum ratio of signal to interference activity), neutron production will essentially only occur in fissionable isotopes. Such photon beams are easily produced by small accelerators (e.g. linear accelerators or “linacs”) where accelerated electrons impinge on a target (of high Z such as tungsten) to produce a bremsstrahlung photon spectrum extending to the energy of interest. In fact, by adjusting the energy of the accelerator one can (if desired) induce fission events over a particular photon energy range (e.g. about 5 MeV to 6 MeV) so that the beam can be “tailored” to investigate the presence of fissionable material. The functional definition of the 5-6 MeV energy range is the energy threshold above which fission neutrons will be produced by the fissionable materials of interest but below the energy threshold where other materials will start producing any significant number of neutrons when interrogated by the photon beam. One or more interrogating photon beams with the same or different photon energy end-points can be considered. More than one photon beam with the same end-point will increase the detection sensitivity of the overall detection system. The use of more than one photon beam with different end-points can improve the specificity for detection of specific fissionable material (see Example 2).

A linac is a sealed tube under vacuum consisting of a source of low-energy electrons at one end and a target made of high Z material (e.g. tungsten) at the other. In between are magnetic focusing lenses designed to keep the electrons geometrically confined so that they will strike the target at the far end. The in-between section is also designed to be a wave guide which allows “traveling waves” to propagate along its length. These waves are generated by “klystrons” which are generally located at the source end of the linac. The low-energy electronic source can be of different types, the simplest being the filament type. A wire is heated and electrons are “boiled off” in relation to the operating temperature.

The filament and some electromagnetic focusing components are typically sold as a single unit called an “electron gun”. The electron gun produces low energy electrons out of its nozzle when a voltage is applied (to heat up the filament). The low energy electrons are picked up by the traveling wave and gain energy as they travel towards the target. The final energy of these electrons is determined by the strength of the traveling wave and defines the operating voltage of the linac (e.g. 5 MeV, 6 MeV, etc.).

The remote operation of a linac can be achieved by voltage wires to the electronic source or the klystron extending from the linac to a remote point of operation. Conventional means to actuate the linac on or off by controlling power to the electronic source is known via the voltage to the filament or voltage to the electromagnetic lenses of the electron gun, i.e. the field lines direct the electrons away from the exit orifice.

Remote operation of the bubble detector can be as simple as remotely controlling a mechanical piston via a variety of means including the use of a reversible stepping motor to drive the piston.

Bubble detectors contain minute superheated droplets of low-boiling point liquid dispersed in a gel. When at atmospheric pressure, the bubble detector emulsion requires no power for operation. Neutrons are detected because of the stored mechanical energy in the superheated droplets. Upon detection of a neutron, the superheated droplet changes state immediately to a vapour bubble. The ˜300-fold change in volume allows one to “see” the result of neutron detection. To operate a bubble detector remotely, one must have a way of “seeing” these bubbles remotely. This can be achieved in many ways, including optical techniques, acoustic techniques, light-scattering techniques with optical reading, imaging, electrical conductivity techniques, sound propagation etc. The electronic signal produced by any of these techniques can be transmitted remotely and read from a distance. For a bubble detector to be insensitive to radiation (i.e. to keep the detector inactive) a certain mechanical pressure must be applied to the gel emulsion to reduce or negate the superheated state. This can be done in many ways. One example, as mentioned above, involves using a mechanical piston driving a liquid as a working fluid. When the piston is activated, the working fluid pushes against the emulsion, exerting the required pressure to keep the bubble detector in its insensitive state. By deactivating the piston, no pressure is exerted by the working fluid and the detector is ready to detect neutron radiation.

### EXAMPLE 1

For detection of fissionable material concealed in a vehicle a linac can be positioned just below the surface of the road at a vehicle check point. Optionally, the linac can be buried vertically so that the photon beam emerges primarily in the upward direction. Small linacs that have (selectable) operating voltages that can produce electrons up to 9 MeV are readily available commercially (e.g. Varian Medical Systems, Linac Systems).

Large neutron detectors (up to several meters high by 1 m wide and 0.5 m thick) that are constructed from a single or an assembly of superheated droplet-type radiation detectors can be placed on the side of the road at the check point in conventional “portal monitor” configurations. The detector(s) can be turned on by remote control when inspection of vehicles is to be performed and left on until inspection is no longer desired. The interrogation of a specific vehicle by irradiating it with a photon beam from the linac will not affect the droplet-type detector(s) response.

When a vehicle at the check point is to be interrogated for the presence of fissionable material, the linac is turned on for a short period of time (e.g. 5 to 500 seconds). High energy photons from the linac penetrate the vehicle bottom to impinge any hidden fissionable material inside. In interacting with fissionable material, the photons will release neutrons that will be detected by the droplet-type detector(s) located beside the vehicle. When the electron beam of the linac is kept below about 6 MeV, neutrons will be produced only by Pu and U (and a few other isotopes of minor importance as discussed above). The presence of bubbles in the detector(s) from neutrons can be used as an indicator of the presence of the fissionable materials. Once bubbles are detected, the detector(s) can be re-set by use of external pressure as normally done in the deployment of droplet-type detector technology.

### EXAMPLE 2

For greater improvement to detection sensitivity two linacs can be used for the interrogation with one linac capable of operating at about 6 MeV while the other linac is capable of operating at about 5 MeV. In this configuration, two irradiations occur sequentially for the same vehicle or object being inspected. Thus, the neutron signal produced by the 6 MeV linac minus the neutron signal from the 5 MeV linac will produce a measure of neutrons produced by the (V, n) reaction for photons between 5 MeV and 6 MeV. This method can provide a signature that is unique to fissionable materials and in particular to Pu and U.

What is claimed is:

1. An apparatus for detection of fissionable material in cargo, waste, subsurface soil and like targets comprising:
a photon source selected to provide a photon beam able to penetrate the target, and able to cause emission of neutrons substantially only from fissionable material to be detected;
detection means including at least one neutron detector of the superheated droplet-type selected and positioned to be substantially unaffected by the photon beam and able to detect, throughout said emission period, fission-derived neutrons; and,
means to read each detector thereby to determine the presence of fissionable material.

2. The apparatus of claim 1, wherein a plurality of photon sources are present.

3. The apparatus of claim 1, wherein a plurality of detectors are positioned in a selected array.

4. The apparatus of claim 1, wherein the photon source provides a continuous beam during detection.

5. The apparatus of claim 1, including two photon sources providing two separate beams.

6. The apparatus of claim 1, wherein the photon energy provided by the source is selected to be about 6 MeV.

7. The apparatus of claim 5, wherein two sources are used and the photon energy from one source is about 6 MeV, and from the other about 5 MeV and wherein the detection system provides a readout of the difference between signals derived from the two beams.

8. The apparatus of claim 1, wherein the photon beam intensity and number of beams are selected to provide the desired detection sensitivity.

9. The apparatus of claim 1, arranged in a vehicle portal monitor configuration for screening packages, vehicles, cargo or rail cars.

10. A method of detecting fissionable material in various targets, comprising:
penetrating the target with a photon beam selected to cause emission of neutrons from fissionable material to be detected over an appropriate period;
detecting the resulting fission-derived neutrons throughout said emission period with selected detector means comprising at least one superheated droplet-type detector; and,
reading the detector means thereby to determine the presence of fissionable material.

11. The method of claim 10, wherein a plurality of photon sources are used.

12. The method of claim 10, wherein the photon energy of the beam is selected to be about 6 MeV.

13. The method of claim 10, wherein two separate photon beams are used.

14. The method of claim 13, wherein the two beams are used sequentially on the same target.

15. The method of claim 14, wherein the photon energy of one beam is about 6 MeV and the other about 5 MeV, and the reading difference is used to determine the presence of fissionable material.

16. The method of claim 10, wherein the beam intensity and number of beams are selected to give the desired detection sensitivity.

17. The method of claim 10, wherein the superheated droplet type detector is re-activated and re-used.

18. The method of claim 10, wherein the detector means includes an array of detectors positioned to optimize detection.

19. The method of claim 15, wherein the fissionable material is primarily U and Pu isotopes.

20. The method of claim 10, wherein the photon beam, detector means and reading-the-detector means, are operated remotely.
